(19) United States
(12) Patent Application Publication
(10) Pub. No.: US 2014/0325480 A1
(43) Pub. Date: Oct. 30, 2014

(54) Software Regression Testing That Considers Historical Pass/Fail Events

(71) Applicant: SUCCESSFACTORS, South San Francisco, CA (US)

(72) Inventor: Ramana Bhagavatula, Palo Alto, CA (US)

(73) Assignee: SuccessFactors, South San Francisco, CA (US)

(21) Appl. No.: 13/872,481

(22) Filed: Apr. 29, 2013

(51) Int. Cl. G06F 11/36

(52) U.S. Cl. CPC G06F 11/368
USPC 717/124

(57) ABSTRACT

Embodiments improve efficiency of creating a risk-based Regression Testing Plan (RTP) for a new version of software, by considering historical pass/fail data of particular regression tests for earlier software versions. Factors taken into account in recommending a particular regression test may include: a number of previous RTPs for earlier versions; a number of those previous RTPs including the particular regression test; the existence of a previous failure of the particular regression test in an earlier version; a date of last failure of the particular regression test in an earlier version; the existence of a previous passage of the particular regression test in an earlier version; a date of last passage of the particular regression test in an earlier software version. Certain regression tests deemed particularly useful (e.g. by a testing authority and/or the software's owner), may be automatically included in the regression test suite and exempted from the recommendation process.

### BACKGROUND

Embodiments of the present invention relate to testing of software, and in particular, to regression testing based upon a history of previous pass/fail events.

Unless otherwise indicated herein, the approaches described in this section are not prior art to the claims in this application and are not admitted to be prior art by inclusion in this section.

In creating a software product, regression testing is employed to make sure that new development does not give rise to unwanted side effects arising from interaction between added features and existing code. Moreover, as additional features are included in the software by successive releases, size of the regression test suite increases.

Scaling of effort to accommodate a larger number of regression tests may be difficult. In particular, reasonable balance is sought to avoid testing every possible available regression test case, while still achieving reasonable confidence in software quality.

A cloud based Software As Service (SAS) product may experience frequent mass releases occurring within a single year. Specifically, after each new deployment, thousands of users with same or different configurations and data sets, may be exposed to the same version of the upgraded software. In such an environment, the need for efficient regression testing may become particularly acute.

Absent engaging in the need/resource balancing calculus described above, either too much time and too many resources are expended testing areas of the product that are not defective, or too much money is allocated to resources to scale up regression testing workload. Achieving the correct and optimum test selection for regression testing is also challenging for the reason that the decision to select appropriate regression test cases may often be subjective, and based upon the exercise of human discretion.

Accordingly, the present disclosure addresses these and other issues with methods and apparatuses implementing regression testing of software that takes into account a past history of pass/fail events.

### SUMMARY

Embodiments improve efficiency of creating a risk-based Regression Testing Plan (RTP) for a new version of software, by considering historical pass/fail data of particular regression tests for earlier software versions. Factors taken into account in recommending a particular regression test may include: a number of previous RTPs for earlier versions; a number of those previous RTPs including the particular regression test; the existence of a previous failure of the particular regression test in an earlier version; a date of last failure of the particular regression test in an earlier version; the existence of a previous passage of the particular regression test in an earlier version; a date of last passage of the particular regression test in an earlier software version. Certain regression tests deemed particularly useful (e.g. by a testing authority and/or the software's owner), may be automatically included in the regression test suite and exempted from the recommendation process. Embodiments are particularly useful in performing regression testing of latest versions of Software As Service (SAS) products slated for widespread release.

An embodiment of a computer-implemented method comprises causing a legacy engine to reference information regarding a previous result of a regression test performed on an earlier version of a software product. The legacy engine is caused to reference a rule set, and the legacy engine is caused to apply the rule set to the previous result to provide a recommendation to perform the regression test on a latest version of the software product.

An embodiment of a non-transitory computer readable storage medium embodies a computer program for performing a method comprising causing a legacy engine to reference information regarding a previous result of a regression test performed on an earlier version of a software product. The method further comprises causing the legacy engine to reference a rule set, causing the legacy engine to apply the rule set to the previous result to provide a recommendation to perform the regression test on a latest version of the software product.

An embodiment of a computer system comprises one or more processors and memory. One or more programs are stored in the memory and configured for execution by the one or more processors. The one or more programs include instructions to cause a legacy engine to reference information regarding a previous result of a regression test performed on an earlier version of a software product. The software program is further configured to cause the legacy engine to reference a rule set. The software program is also configured to cause the legacy engine to apply the rule set to the previous result to provide a recommendation to perform the regression test on a latest version of the software product.

According to some embodiments the previous result includes a number of times the regression test was previously performed on earlier versions of the software product, and the rule set includes a threshold number of times the regression test was previously performed on earlier versions of the software product.

In certain embodiments the previous result includes a latest date of passage or failure of the regression test by earlier versions of the software product, and the rule set includes a time period within which the passage or failure of the regression test by earlier versions of the software is considered.

In particular embodiments the previous result includes a number of earlier versions of the software product that were subjected to regression testing, and the rule set considers the number of earlier versions of the software product for which regression testing was performed.

According to various embodiments the legacy engine is caused to automatically recommend performing the regression test on the latest version of the software product, based upon a designation by a tester or by a software owner.

In particular embodiments the information is stored in a database, and the designation comprises a field in the database.

In certain embodiments the software product comprises a cloud based Software As Service product.

The following detailed description and accompanying drawings provide a better understanding of the nature and advantages of particular embodiments.

### BRIEF DESCRIPTION OF THE DRAWINGS

FIG. 1 shows a simplified overview of an embodiment of a system for determining a regression test suite for a new version of a software product.

FIG. 2 shows expression of a recommendation process according to an embodiment, in the form of a flowchart.

FIG. 3 shows a recommendation process of FIG. 2, expressed as a series of textual statements with annotations.

FIG. 4 shows concrete expression of a recommendation process of FIGS. 2 and 3, in the form of a Mysql query.

FIG. 5 illustrates hardware of a special purpose computing machine configured to perform a process according to an embodiment.

FIG. 6 illustrates an example of a computer system.

### DETAILED DESCRIPTION

Described herein are techniques for regression testing of software. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Most cases of software development involve the following two (2) phases for quality testing. A first phase (1) involves ensuring that new features are free from bugs, and fixing any bugs that may arise.

This first phase verifies that changes to code do not cause unwanted defects using new/existing tests. In such first phase testing, the parameters used to certify the changes to the code tend to be well scoped, and are usually tested to match 100% of the scope.

A second phase (2) is regression testing. In this second phase, regression tests are run to ensure that the existing areas of the software unchanged by the addition of new features, have not been negatively impacted by the changes in new software development.

This second, regression testing phase typically commonly consumes between about 50-70% of the effort of the test teams. As described above, a calculus involving balancing different considerations to determine a proper scope of the regression testing/size of the regression test suite (e.g. a number of regression tests that are to be run), plays a role in the amount of effort that is to be expended in order to test the software.

Accordingly embodiments improve efficiency of creating a risk-based Regression Testing Plan (RTP) for a new version of software, by considering historical pass/fail data of particular regression tests for earlier software versions. Factors taken into account in recommending a particular regression test may include but are not limited to:
a number of previous RTPs for earlier versions;
a number of those previous RTPs including the particular regression test;
the existence of a previous failure of the particular regression test in an earlier version of the software;
a date of last failure of the particular regression test in an earlier version;
the existence of a previous passage of the particular regression test in an earlier version of the software;
a date of last passage of the particular regression test in an earlier software version.

Certain regression tests that are deemed to be particularly useful (e.g. by a testing authority and/or software vendor or owner), may be automatically included in the regression test suite and exempted from the recommendation process.

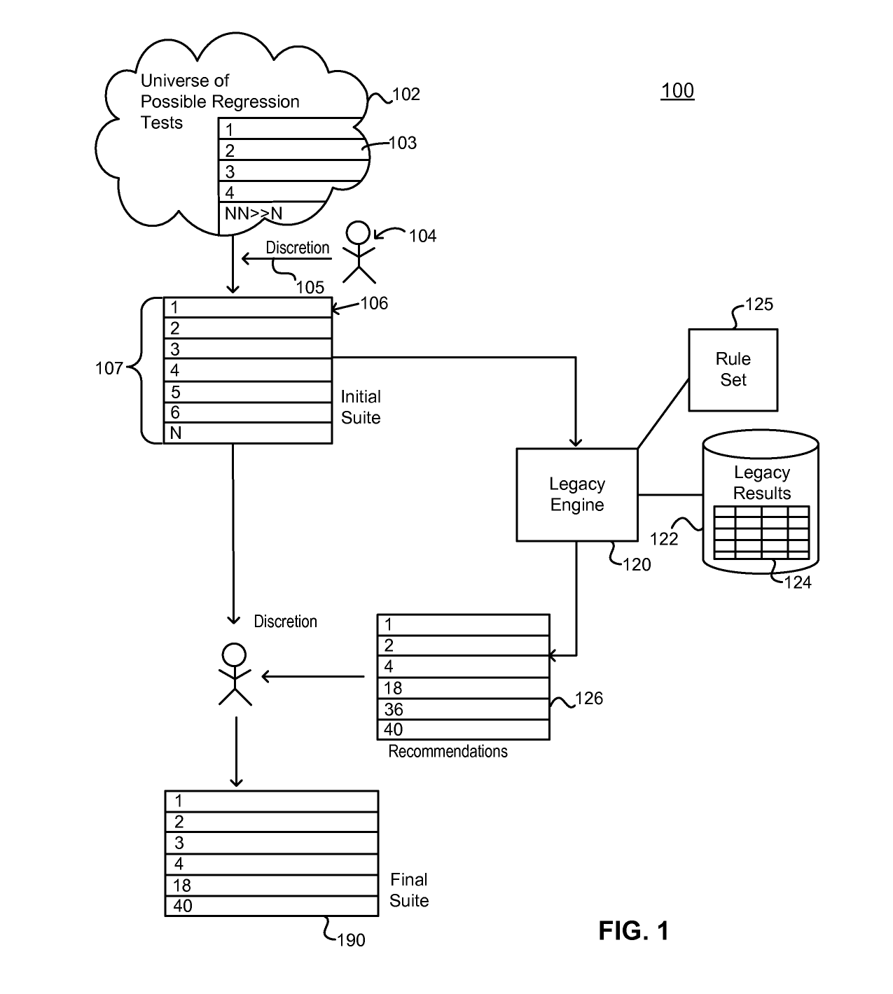

FIG. 1 shows a simplified overview of an embodiment of a system for determining a regression test suite for a new version of a software product. In particular, system 100 comprises a universe 102 of possible regression tests 103 that could conceivably be performed on a new software version.

A total number (NN) of possible regression tests that could be run, is very large. Accordingly, FIG. 1 shows the exercise of discretion 105 by human tester 104, to narrow the universe of possible regression tests to an initial regression test suite 106 comprising individual regression tests 107.

The discretion exercised by the human tester at this or other stages of the regression testing process, can be determined by a number of factors. Such factors may include but are not limited to:
the education, knowledge, and experience of the human tester in performing regression testing on this software product and on other software products;
the possible testing resources available;
the circumstances of impending release of the latest version of the software product;
a type of the software product;
a type of new features added over earlier version(s) of the software product;
a number of new features added over earlier version(s) of the software product;
customer usage;
impact;
changed areas;
cross module impacts.

In creating the initial regression testing suite, the tester has narrowed somewhat the scope of a possible number of regression tests. However, the remaining number (N) of regression tests that could be run is still large, and likely exceeds the available testing resources (e.g. time, manpower, cost).

Accordingly, there is a need for a process in which recommendations may be provided to the tester, in order to further narrow the field of regression tests to those offering the best likelihood of revealing a defect in the latest version of the software.

The embodiment of the system 100 thus includes a legacy engine 120 that is in communication with a non-transitory computer readable storage medium 122. The non-transitory computer readable storage medium may operate based upon magnetic, electronic, optical, semiconducting, or other physical principles.

Stored thereon in the form of a database 124, is data relating to historical regression testing performed on earlier versions of the software product. Thus the database may include fields identifying particular regression tests by name and/or number, as well as the results of application of those regression tests to the prior software versions, including software version number, failure dates, passage dates, and other information. Also stored in the database may be information indicating particular value or importance of a specific regression test to the tester and/or to the owner of the software.

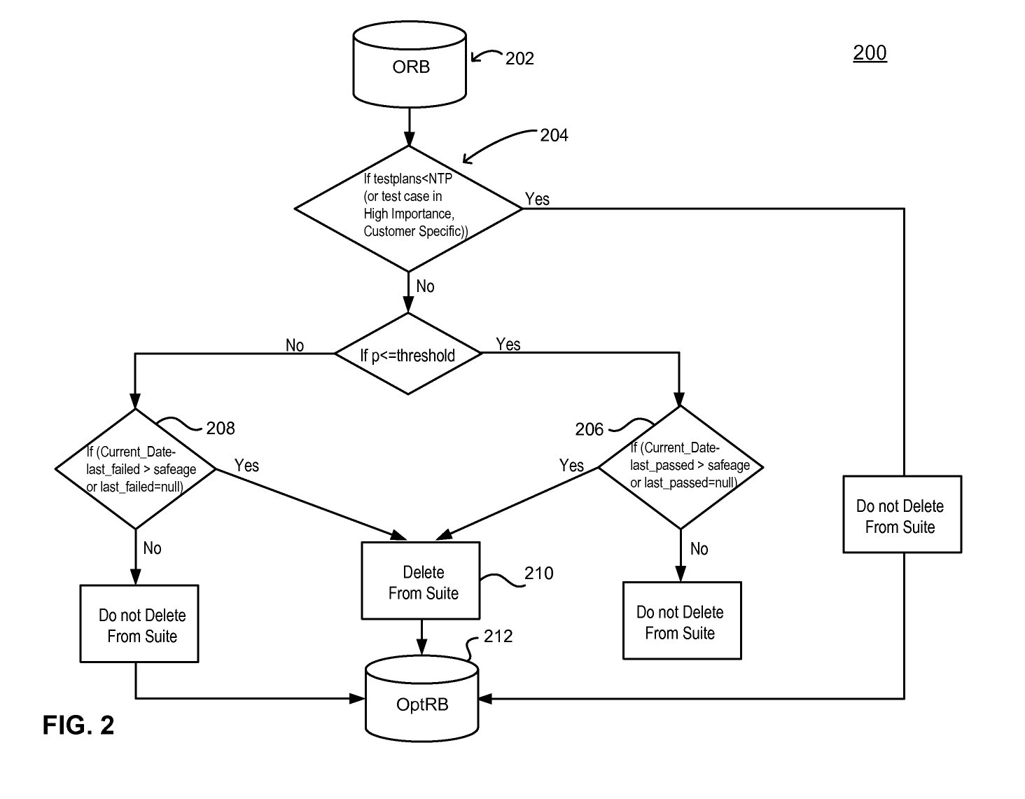

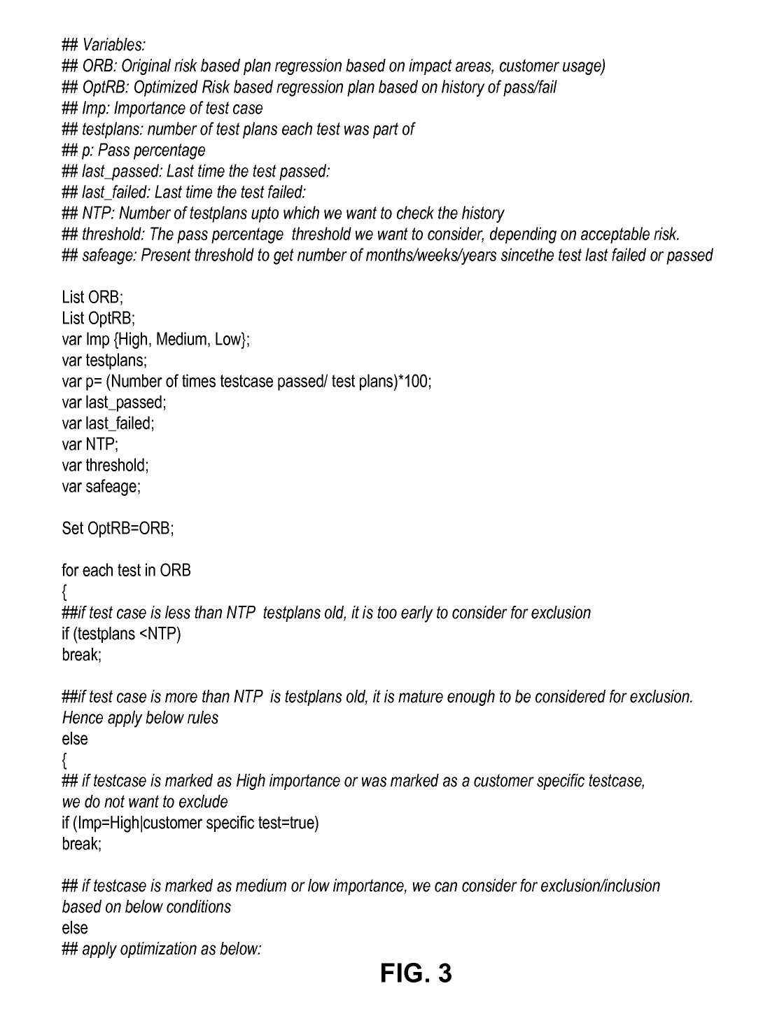

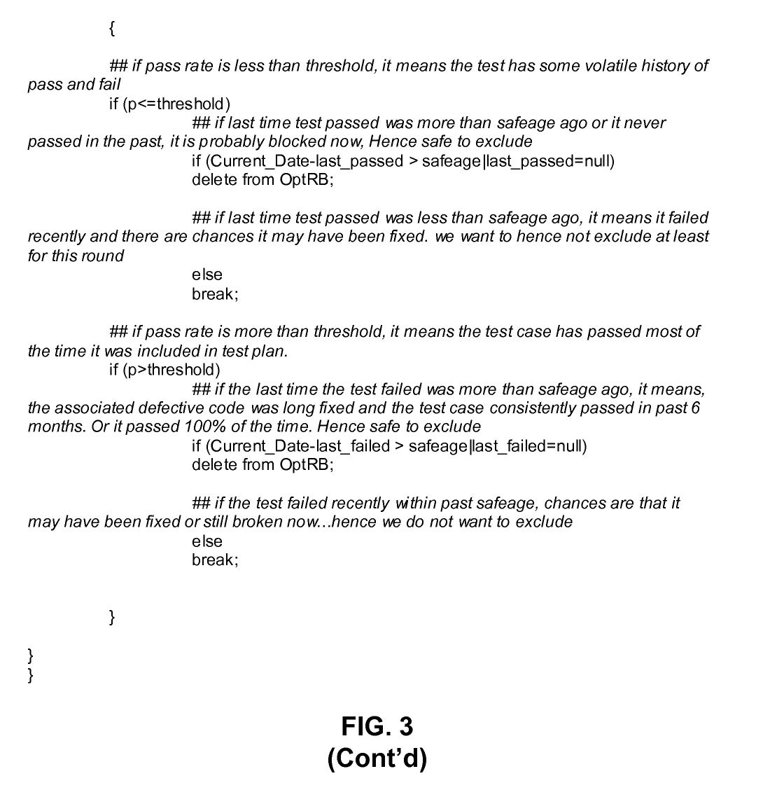

The legacy engine is in communication with the legacy results stored in the database. The legacy engine is also in communication with a rule set 125. An example of the rules that may be expressed in the rule set 125, is described below in connection with FIGS. 2 and 3.

Given input to the legacy engine in the form of the initial regression testing suite, the legacy engine is configured to reference the stored database information and the rule set. The legacy engine is configured to execute a process to produce an output in the form of a recommended regression testing suite 126.

In a final step, the human tester is positioned to come up with a final suite 190 of regression tests that are to be applied to the latest software version. In arriving at this final suite, the human tester is in possession of not only his education and experience in connection with past software testing, but may also reference the objective recommendations prepared by the legacy engine in the form of the recommended suite. In the end, the final suite selected according to the discretion of the human tester, may include tests (e.g. test 2) outside those of the recommended suite.

FIG. 2 shows expression of a recommendation process according to an embodiment, in the form of a flow chart 200. FIG. 3 shows the recommendation process of FIG. 2, expressed as a series of textual statements with annotations.

In a first step 202 of FIG. 2, the Original Risk-Based TestPlan (ORB) is provided. In a second step 204, each individual regression test of the ORB is subjected to initial criteria. Specifically, there can be one or more attributes that are attached to each test case that can reflect how valuable the testcase is.

One such initial criterion may be whether the regression test has been applied to a threshold number of test plans (NTP) for previous versions (testplans). Thus if the test was executed as part of none or only a few test plans in the past, it is likely that the regression test will be retained, and not deleted from the ORB, because there are not enough historical data points to subject the test case for further criteria

If, however, testplans >NTP, the regression test is subject to additional initial criteria. One such additional initial criterion is whether the particular regression test is considered of particular value by a tester. In certain embodiments, this designation may be performed manually by the tester. In some embodiments, this designation may be indicated by a particular field present within a database containing a record of the legacy results. If the test is considered valuable by the tester, that regression test is accordingly retained in the recommended test suite and is not deleted.

Another additional initial criterion, is whether the particular regression test is designated by an owner of the software as being of particular value. In certain embodiments, this designation may be performed manually by the tester. In some embodiments, this designation may be indicated by a particular field present within a database containing a record of the legacy results. Again, if the test is considered valuable by the software owner, that regression test is retained and not deleted.

For the remaining regression tests, a next step 206 determines whether a particular regression test has “passed” a threshold (p) number of times or more, on an earlier software version. If the regression test has “passed” a threshold number of times (p) in connection with earlier software versions, a further test is applied in step 208.

Specifically, step 208 asks whether a previous software version has ever failed the regression test, and if so, the date of that last failure. If the date of last failure is beyond a certain time limit (safeage) or the test has never failed, the test is considered likely to be passed yet again, and is recommended as a test that can be deleted from the ORB in step 210. If the date of last failure is within safeage, the test is considered to be of continuing possible relevance and is not recommended to be deleted from the ORB in step 212. It then becomes a part of the recommended test suite, here referred to as the Optimized Risk-Based Testplan (OptRB).

If the testcase passed less than the threshold (p) number of times, in previous software versions, is also considered by the process in determining ongoing relevance to a regression test suite. Thus further test is applied to find out whether a previous software version had ever passed the regression test, and if so, the date of that last passage.

If the date of the last passage of the regression test is beyond the safeage time limit or the test has never passed in the past, the test is considered as being blocked by a defect and likely to fail again. It is then recommended to be deleted from the ORB in step 210 as unlikely to uncover a newer defect in software by executing that test case. If the test case passed recently, but had failed considerable times in the past, it is retained within ORB in because it is not mature enough yet to be considered consistently passing and risk free to not execute again.

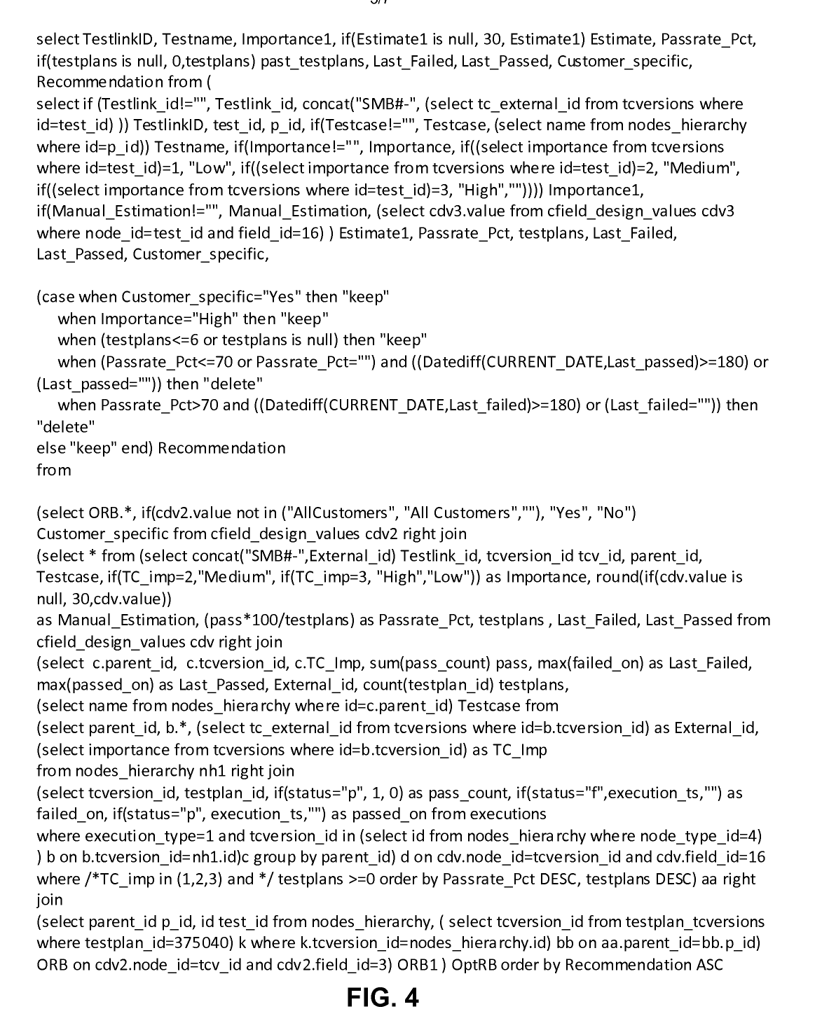

Several points are noted. First, the regression testing approach according to embodiments is highly practical. This methodology can be readily automated in order to generate an optimum test plan. As a concrete example, FIG. 4 shows translation of the process of FIGS. 2-3 into the form of a Mysql query, in order to generate the optimized list.

The process of FIGS. 2-3 is also adaptable. Selection of the value of the NTP, of the threshold (p), and/or of the safeage, allows adjustment of the risk to be undertaken in determining what tests are to be applied. In one specific instance, NTP was set at 6; the threshold (p) was set at 70%; and a safeage was set at 6 months. In this manner, various embodiments can be adaptive to the specific risks and challenges of products/testing teams.

Also worthy of note is that embodiments may allow the regression testing workload to be conserved. Specifically, an initial analysis shows a saving of on average 30% of workload in executing a regression test suite, by adding the dimension offered by application of the algorithm, to the exercise of human discretion. This extra time savings can aid in scaling and allow focus upon more areas in testing, which may not have been possible otherwise.

In summary, embodiments may contribute another dimension to existing methodologies for selecting regression test cases in the construction of regression test plans. This offers potential to conserve valuable time for the testing resources available, by spending less time on tests that have high probability to pass, and helps gain time for Quality Assurance (QA) teams to spend more time on regression test cases offering the promise of revealing more defects, and/or other testing activities.

Embodiments may be adaptable to a variety of software products, and accommodate flexibility in handling levels of risk with which various stakeholders (e.g. the tester, the software owner) are comfortable. Embodiments also contribute additional objective information to the decision making process, allowing those stakeholders to easily agree/disagree on particulars of a regression testing strategy.

In conclusion, embodiments propose a methodical analysis of the historical information available on the test cases passing/failing for previous software versions. This information may thus be available to a tester, in addition to other factors such as test case importance, test case maturity, and/or human discretion to optimize the regression testing suite. Optimization of the testing suite may help reduce the workload for the testing resources, while still maintaining high quality of the delivered product. It can also save money resources for the company and also make the testing team more efficient.

Embodiments may find particular value in performing efficient regression testing of latest versions of Software As Service (SAS) products, that are slated for widespread release over the cloud. This is attributable to the tight constraints imposed on regression testing by the rapid evolution of such products and their simultaneous release to many users.

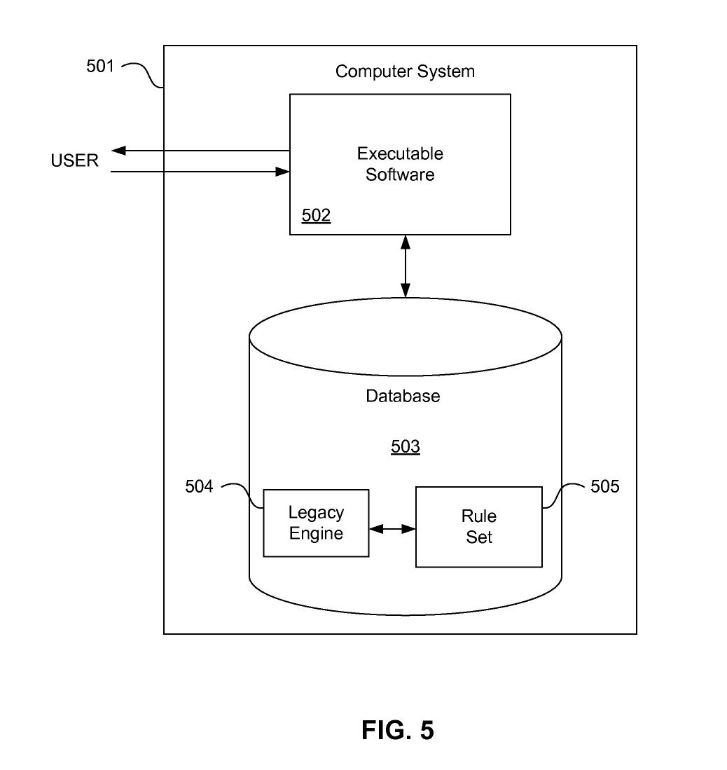

FIG. 5 illustrates hardware of a special purpose computing machine configured to perform regression testing according to an embodiment. In particular, computer system 500 comprises a processor 502 that is in electronic communication with a non-transitory computer-readable storage medium 503. This computer-readable storage medium has stored thereon executable instructions 504 corresponding to a legacy engine. Executable instructions 505 corresponds to a rule set. Executable instructions may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

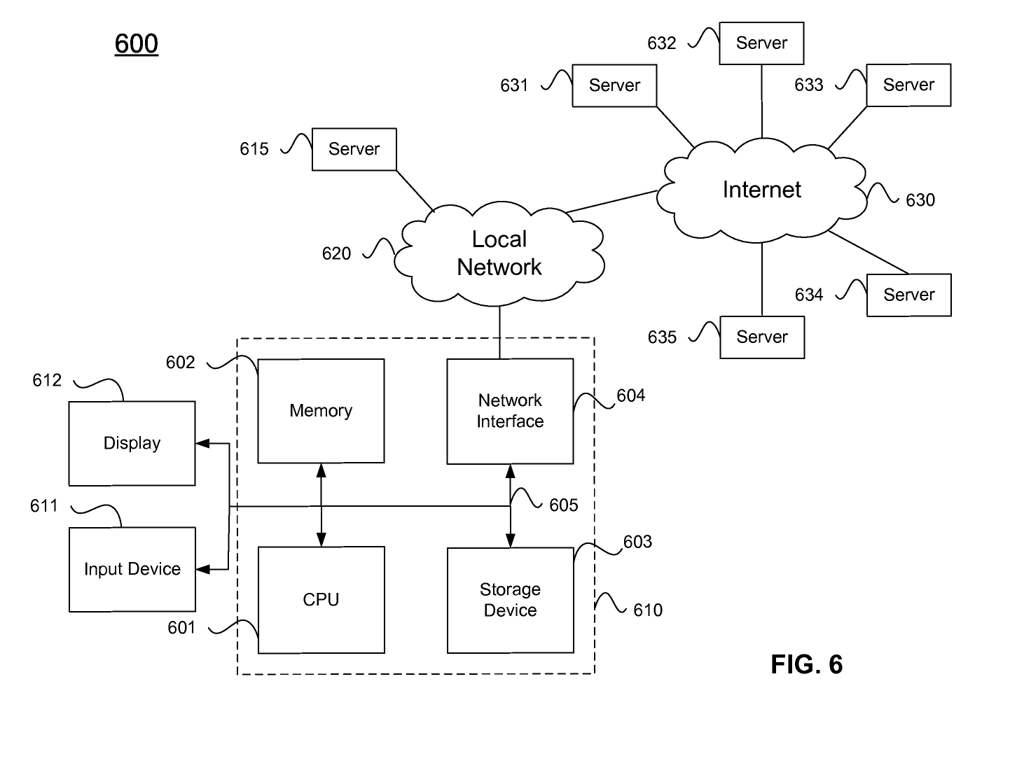

An example computer system 610 is illustrated in FIG. 6. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable mediums.

Computer system 610 may be coupled via bus 605 to a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 310 may communicate with a plurality of other computer machines, such as server 615. Accordingly, computer system 610 and server computer systems represented by server 615 may form a cloud computing network, which may be programmed with processes described herein. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing a legacy engine to reference information regarding a previous result of a regression test performed on an earlier version of a software product;
causing the legacy engine to reference a rule set; and
causing the legacy engine to apply the rule set to the previous result to provide a recommendation to perform the regression test on a latest version of the software product.

2. A method as in claim 1 wherein:
the previous result includes a number of times the regression test was previously performed on earlier versions of the software product; and
the rule set includes a threshold number of times the regression test was previously performed on earlier versions of the software product.

3. A method as in claim 1 wherein:
the previous result includes a latest date of passage or failure of the regression test by earlier versions of the software product; and
the rule set includes a time period within which the passage or failure of the regression test by earlier versions of the software is considered.

4. A method as in claim 1 wherein:
the previous result includes a number of earlier versions of the software product that were subjected to regression testing; and
the rule set considers the number of earlier versions of the software product for which regression testing was performed.

5. A method as in claim 1 wherein the legacy engine is caused to automatically recommend performing the regression test on the latest version of the software product, based upon a designation by a tester or by a software owner.

6. A method as in claim 5 wherein the information is stored in a database, and the designation comprises a field in the database.

7. A method as in claim 1 wherein the software product comprises a cloud based Software As Service product.

8. A non-transitory computer readable storage medium embodying a computer program for performing a method, said method comprising:
causing a legacy engine to reference information regarding a previous result of a regression test performed on an earlier version of a software product;
causing the legacy engine to reference a rule set; and
causing the legacy engine to apply the rule set to the previous result to provide a recommendation to perform the regression test on a latest version of the software product.

9. A non-transitory computer readable storage medium as in claim 8 wherein:
the previous result includes a number of times the regression test was previously performed on earlier versions of the software product; and
the rule set includes a threshold number of times the regression test was previously performed on earlier versions of the software product.

10. A non-transitory computer readable storage medium as in claim 8 wherein:
the previous result includes a latest date of passage or failure of the regression test by earlier versions of the software product; and
the rule set includes a time period within which the passage or failure of the regression test by earlier versions of the software is considered.

11. A non-transitory computer readable storage medium as in claim 8 wherein:
the previous result includes a number of earlier versions of the software product that were subjected to regression testing; and
the rule set considers the number of earlier versions of the software product for which regression testing was performed.

12. A non-transitory computer readable storage medium as in claim 8 wherein the legacy engine is caused to automatically recommend performing the regression test on the latest version of the software product, based upon a designation by a tester or by a software owner.

13. A non-transitory computer readable storage medium as in claim 12 wherein the information is stored in a database, and the designation comprises a field in the database.

14. A non-transitory computer readable storage medium as in claim 8 wherein the software product comprises a cloud based Software As Service product.

15. A computer system comprising:
one or more processors and memory;
one or more programs stored in the memory and configured for execution by the one or more processors, the one or more programs including instructions to:
cause a legacy engine to reference information regarding a previous result of a regression test performed on an earlier version of a software product;
cause the legacy engine to reference a rule set; and
cause the legacy engine to apply the rule set to the previous result to provide a recommendation to perform the regression test on a latest version of the software product.

16. A computer system as in claim 15 wherein:
the previous result includes a number of times the regression test was previously performed on earlier versions of the software product; and
the rule set includes a threshold number of times the regression test was previously performed on earlier versions of the software product.

17. A computer system as in claim 15 wherein:
the previous result includes a latest date of passage or failure of the regression test by earlier versions of the software product; and
the rule set includes a time period within which the passage or failure of the regression test by earlier versions of the software is considered.

18. A computer system as in claim 15 wherein:
the previous result includes a number of earlier versions of the software product that were subjected to regression testing; and
the rule set considers the number of earlier versions of the software product for which regression testing was performed

19. A computer system as in claim 15 wherein the legacy engine is caused to automatically recommend performing the regression test on the latest version of the software product, based upon a designation by a tester or by a software owner.

20. A computer system as in claim 19 wherein the information is stored in a database, and the designation comprises a field in the database.
